(19) United States
(12) Patent Application Publication
(10) Pub. No.: US 2024/0001504 A1
(43) Pub. Date: Jan. 4, 2024

(54) METAL STRIP PRODUCTION BY GRINDING

(71) Applicant: Berndorf Band GmbH, Berndorf (AT)

(72) Inventor: Johannes Günther SIMMEL, Neudörfl (AT)

(21) Appl. No.: 18/254,362

(22) PCT Filed: Nov. 25, 2021
(86) PCT No.: PCT/AT2021/060449

§ 371 Date: Sep. 25, 2023

(30) Foreign Application Priority Data
Nov. 27, 2020 (AT) A51043/2020

(51) Int. Cl. B24B 21/04; B23P 15/00; B24B 7/12; B21D 53/14; B21D 1/02

(52) U.S. Cl. CPC B24B 21/04; B23P 15/00; B24B 7/12; B21D 53/14; B21D 1/02

(57) ABSTRACT

A method for producing a metal belt, in which the metal belt is ground at least on one side over essentially the entire surface. In a first step, a transverse curvature in the direction of the belt width is produced on the metal belt by straightening machining, wherein a first side of the metal belt is convexly shaped and a second side of the metal belt opposite the first side is at least planar or concave in shape, and in a second step, the course of the belt thickness in the direction of the belt width is changed to a uniform course of a value of the belt thickness.

The invention relates to a method for producing a metal belt, in which the metal belt is ground at least on one side over essentially the entire surface.

So-called endless belts, preferably made of steel, are a central component of a wide variety of production plants, for example in the furniture industry for the manufacture of chipboard or laminates for flooring, but also for the production of films for use in photography or for the manufacture of LCD screens. Metal belts for such applications have to meet high demands in terms of surface quality. For this purpose, they are usually ground and polished and/or highly polished. In the manufacture of LCD screens, for example, the liquid or paste-like material is applied to a moving metal belt and the at least partially solidified material is then lifted off as a film. The surface quality of the product produced with such a metal belt is directly dependent on the surface quality of the metal belt.

The starting material for the production of the metal belts according to the invention is steel belts as supplied as semi-finished products from steel rolling mills. It is known from belts produced in rolling technology that thickness non-uniformities can occur in the direction of the belt width of the metal belts. These are caused by deflection of the rolls as a result of the reaction forces occurring during machining of the metal belts. On the other hand—in order to achieve the desired high surface qualities of the metal belts—it is necessary to subject the roll-finished metal belts to further machining. In addition to a belt thickness that is as uniform as possible, a high flatness of the metal belt and a surface roughness that is as low as possible are to be achieved. Due to the fact that such metal belts sometimes have areas of several 100 m², their machining represents an extremely demanding task.

The object of the invention is to create a method for manufacturing a metal melt, by means of which method metal belts with a high thickness uniformity as well as with a high flatness and surface quality can be produced particularly effectively.

The object of the invention is achieved by a method for manufacturing a metal belt, in which the metal belt is ground on at least one side over essentially the entire surface. In a first step, a transverse curvature in the direction of the belt width is produced on the metal belt by directional machining, wherein a first side of the metal belt is convexly shaped and a second side of the metal belt opposite the first side is at least planar or concave in shape, and in a second step, the profile of the belt thickness D in the direction of the belt width is changed to a uniform profile of a value of the belt thickness D by grinding the second side of the metal belt (D(x)=constant).

According to a preferred method, in the first step the transverse curvature of the metal belt is created with a concavely shaped second side of the metal belt.

It has been found to be particularly advantageous that the metal belt is closed to form an endless belt before the second side is ground, in particular by welding free ends of the endless belt or by a helical weld.

In a preferred further embodiment of the invention, the endless belt can be arranged to circulate between two rollers prior to grinding.

In the above context, it has been found to be particularly advantageous if the endless belt is moved relative to a belt grinding device during grinding. This variant of the invention makes it possible to realize a very homogeneous grinding process in a simple manner.

An embodiment in which the metal belt is closed after straightening to form the endless belt has proved particularly effective.

It has been found to be particularly advantageous if the grinding process introduces a residual compressive stress into the metal belt which corresponds to a residual compressive stress introduced into the metal belt by the straightening process.

For the purpose of better understanding of the invention, this will be elucidated in more detail by means of the figures below.

These show in a respectively very simplified schematic representation:

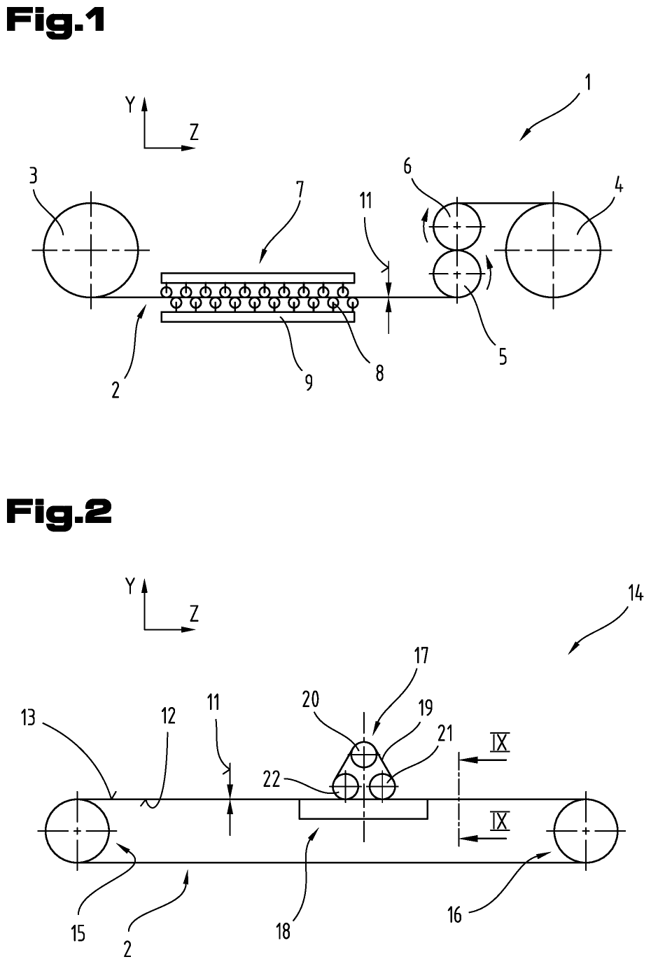

FIG. 1 a device for straightening a metal belt in side view;

FIG. 2 a side view of a device for grinding the metal belt;

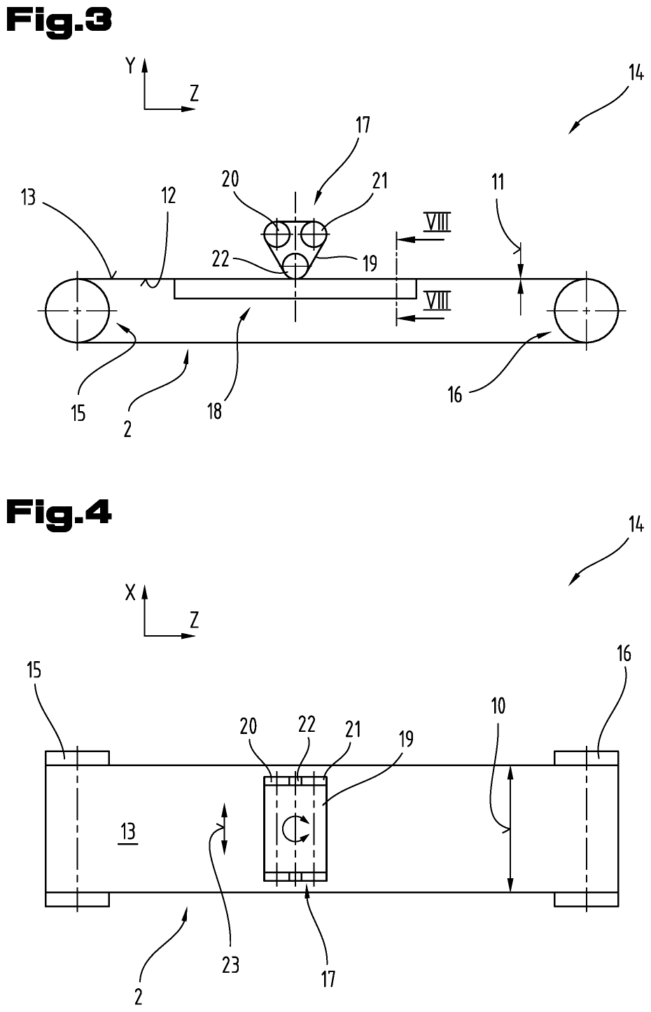

FIG. 3 an alternative embodiment of a plant for grinding the metal belt in side view;

FIG. 4 the plant for grinding the metal belt according to FIG. 3 in top view from above;

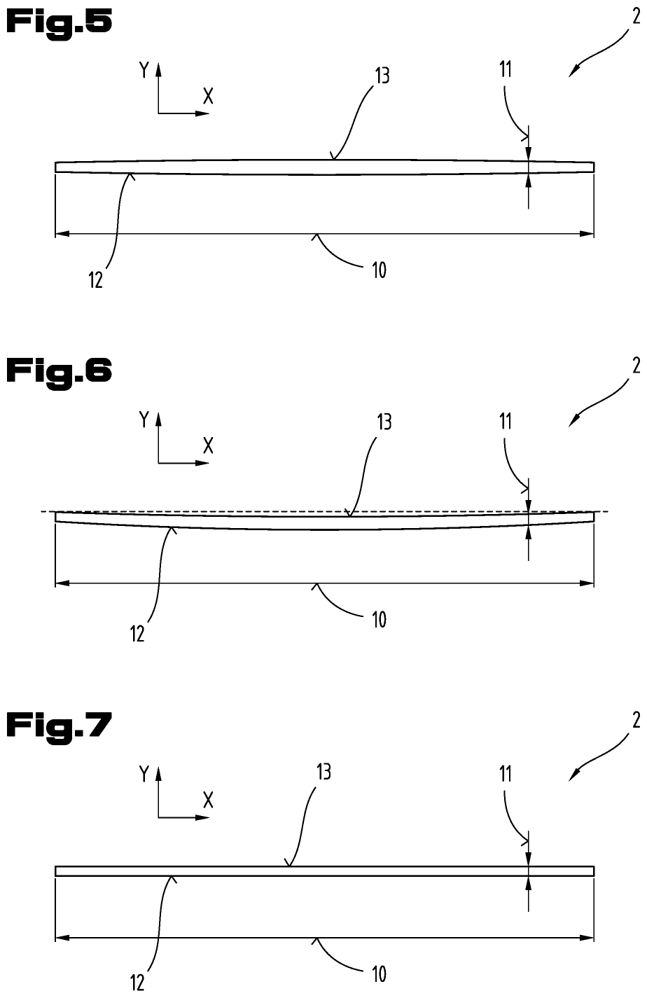

FIG. 5 a cross section of the metal belt in the direction of the belt width;

FIG. 6 a cross section of the metal belt in the direction of the belt width with a transverse curvature;

FIG. 7 the cross section of the metal belt in its condition after machining;

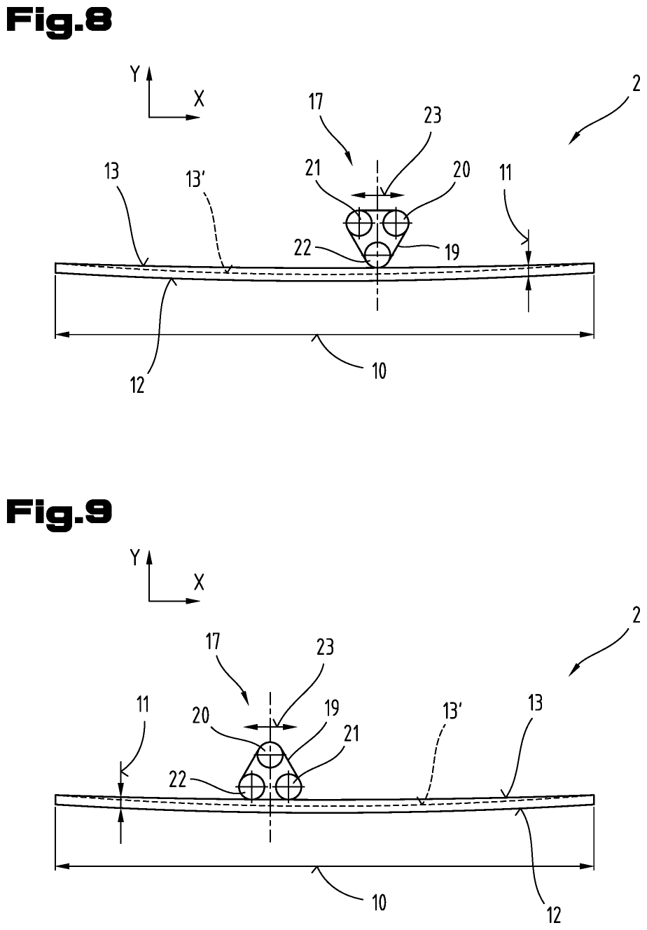

FIG. 8 a detail of the plant for grinding the metal belt according to FIG. 3;

FIG. 9 a detail of the plant for grinding the metal belt according to FIG. 2.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

Using the devices shown in FIGS. 1 to 4, the process for producing a metal belt is described below.

FIG. 1 shows a device 1 for straightening a metal belt 2 in side view. The straightening device 1 includes two reels 3, 4, two drive rolls 5, 6 and a straightening machine 7. The straightening machine 7 in turn comprises several rollers arranged one behind the other and adjustable transversely to the metal belt 8 which are arranged on a machine frame 9. When straightening the metal belt 2 the metal belt 2 is guided through the group of upper and lower rollers 8, so that a kind of serpentine line is passed (not shown) and the metal belt 2 is bent in both directions. The upper and lower rollers 8 are adjusted in such a way that a straight section of the metal belt 2 reaches, but does not exceed its yield point in both bending directions. Unstraight or uneven sections of the metal belt 2 however, exceed the yield point and are thus plastically (permanently) straightened, while straight sections retain their desired shape.

The raw material used in the process is a bright metal belt 2. Such metal belts 2 may have a course of a beltthickness in the direction of its belt width 10 which, for example, becomes thinner from a belt center to belt edges, as shown in FIG. 5. FIG. 5 shows a cross section of the metal belt 2 in the direction of the belt width 10. The initially unmachined metal belt 2 may have a course of a belt thickness 11 in the direction of the belt width 10 wherein the belt thickness 11 can be greater in the region of the belt center than in the region of the belt edges. Expressed as a function of the x coordinate in the direction of the belt width 10 the belt thickness 11, D(x), may have a maximum in the area of the belt center of the metal belt 2 (d² D(x)/dx²<0). However, it should be expressly emphasized at this point that in the illustration of FIG. 5, the non-uniformity of the belt thickness 11 is only shown enlarged out of scale for better clarification.

When straightening the metal belt 2 in the device 1 (FIG. 1), it is provided according to the invention that the metal belt 2 is machined in a first step of the process in such a way that a transverse curvature is formed in the direction of the belt width 10. This means that the metal belt 2 is additionally deformed by the straightening operation in such a way that essentially a concave-convex shape or cross section is obtained, as shown in FIG. 6. That is, after straightening, a first side 12 of the metal belt 2 has a convex curvature. A second side opposite the first side, on the other hand, has a concave curvature. This transverse curvature of the metal belt 2 is achieved by adjusting the rollers 8 of the straightening machine 7. While the metal belt 2 is deformed by straightening in the device 1 with respect to its longitudinal extension (z direction) in such a way that it is aligned flat or straight, the metal belt 2 is plastically deformed in the direction of the belt width 10 in such a way that the described transverse curvature is obtained. The shape of the cross section of the metal belt 2 in the direction of the belt width 10 thus undergoes a transition from a biconvex shape (FIG. 5) to a concave-convex shape (FIG. 6) or at least to a plano-convex shape. The curvature of the first side 12 is thus increased, while the curvature of the second side 13 is changed from a convex shape to a concave shape.

In the process for manufacturing the metal belt 2 according to the invention the second, i.e. the concave, side 13 of the metal belt 2 is machined by grinding.

FIG. 2 shows a plant 14 for grinding the metal belt 2 in side view. The metal belt 2 is formed into an endless belt after processing in the straightening device 1 and thus guided around two rollers 15, 16 of the plant 14 for grinding. The endless belt can be made by joining, in particular welding, free ends of the metal belt 2 by means of a transverse weld. Alternatively, longitudinal edges of the metal belt 2 can be welded together with a helical weld to form an endless belt of large width. The plant 14 for grinding the metal belt 2 further comprises a belt grinding device 17 and a counter plate 18 for supporting the metal belt 2. From the two rollers 15, 16 at least one is driven and the metal belt 2 can thus be moved under the belt grinding device 17 or pulled over the counter plate 18. During the intermittent or continuous movement of the metal belt 2 under the belt grinding device 17 material is removed from the second side 13. The belt grinding device 17 comprises a grinding belt 19 to this purpose which is guided around three deflection rollers 20, 21 and 22. The grinding belt 19 is according to this embodiment put into abutment by the two lower deflection rollers 21, 22 over the entire surface of the second side 13 of the metal belt 2 By grinding the metal belt 2 using the belt grinding device 17 so much material is removed from its second side 13 that values of the belt thickness 11 in the direction of the belt width 10 finally have a uniform course (FIG. 7). Ideally, the metal belt 2 has after grinding with the belt grinding device 17 a course of the belt thickness 11 over the entire belt width 10 where the value of the belt thickness 11 is constant (D(x)=constant). According to the invention, it is provided that only on the one second side 13 of the metal belt 2 material is removed by grinding.

Surprisingly, it has been shown that by machining the metal belt 2 where first a transverse curvature is created on the metal belt 2 and then the second side 13, i.e. the concavely shaped side, of the metal belt 2, is machined by grinding, during the grinding process also a plastic deformation takes place so that the metal belt 2 finally assumes a flat shape (FIG. 7).

FIG. 7 shows the cross section of the metal belt 2 in its condition after machining by the method according to the invention. The metal belt 2 has in this condition a constant value of its belt thickness 11 over its entire belt width 10. In addition, the shape of the first side 12 as well as the shape of the second side 13 is flat, i.e. essentially planar.

An alternative embodiment of a plant 14 for grinding the metal belt 2 is described by means of FIGS. 3 and 4. FIG. 3 shows a side view of the plant 14 and FIG. 4 a top view from above. The deflection rollers 20, 21, 22 of the grinding belt 19 of this belt grinding device 17 are arranged in such a way that the surface of the grinding belt 19 and the metal belt 2 are in contact along a line. This type of line contact allows the metal belt 2 to be abraded in a particularly targeted manner at relatively low grinding pressure. As can be seen better from FIG. 4, the belt grinding device 17 may be adapted during the machining of the metal belt 2 in the lateral direction of the metal belt 2, i.e. in the direction of the belt width 10, or in the direction of the belt width at the side 13 of the metal belt 2 in an oscillating manner (arrow 23). In addition, the belt grinding device 17 may also be rotated relative to a vertical axis (y direction), which changes the direction of the grinding movement of the grinding belt 19 on the side 13 of the metal belt 2.

FIG. 8 shows a detail of the plant 14 for grinding the metal belt 2 according to FIG. 3, wherein only the metal belt 2 and the belt grinding device 17 are shown. According to this embodiment of the plant 14 for grinding the metal belt 2 the belt grinding device 17 is configured in such a way that the grinding belt 19 is in abutment with the metal belt 2 along a line and in this way the grinding takes place. During the machining of the second side 13 of the metal belt 2 the belt grinding device 17 is moved in the direction of the belt width 10 over the side 13 back and forth (arrow 23). In this way, material is removed from the metal belt 2 until a uniform belt thickness 11 in the direction of the belt width 10 corresponding to the side 13 indicated by a stroke-dotted line is achieved.

FIG. 9 shows a detail of the plant 14 for grinding the metal belt 2 according to FIG. 2. According to this embodiment, the belt grinding device 17 is configured in such a way that the deflection rollers 20, 21, 22 are arranged in such a way that the grinding belt 19 is in flat abutment on the side 13 of the metal belt 2. During the machining of the metal belt 2, the belt grinding device 17 may be moved in the direction of the belt width 10 over the side 13 back and forth. In addition, it is also possible to rotate or swivel the belt grinding device 17 relative to a vertical axis (y direction). This will change the direction of movement of the grinding belt 19 relative to the side 13 of the metal belt 2 as necessary. By grinding the second (concave) side 13 of the metal belt 2 finally two things are achieved. The course of the belt thickness 11 in the direction of the belt width 10 is changed to a uniform course of the value of the belt thickness 11. And in addition, by the grinding processing of the second side 13 of the metal belt 2 a deformation of the cross section of the metal belt 2 is achieved at the same time in the direction of a planar shape, as shown in FIG. 7. Grinding can introduce a residual compressive stress into the metal belt that is equivalent to a residual compressive stress introduced into the metal belt by straightening.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### LIST OF REFERENCE NUMBERS

1 Straightening device
2 Metal belt
3 Reel
4 Reel
5 Drive roll
6 Drive roll
7 Straightening machine
8 Roller
9 Machine frame
10 Tape width
11 Belt thickness
12 Side
13 Side
14 Plant
15 Roller
16 Roller
17 Belt grinding device
18 Counter plate
19 Grinding belt
20 Deflection roller
21 Deflection roller
22 Deflection roller
23 Arrow

1. Method for producing a metal belt, wherein the metal belt is ground on at least one side over substantially the entire surface, comprising: in a first step, a transverse curvature in the direction of the belt width is produced on the metal belt by a straightening operation, wherein a first side of the metal belt is convexly shaped and a second side of the metal belt opposite the first side is at least planar or concave in shape, and in that, in a second step, by grinding the second side of the metal belt, the course of the belt thickness D in the direction of the belt width is changed to a uniform course of a value of the belt thickness D (D(x)=constant).

2. The method according to claim 1, wherein in the first step the transverse curvature of the metal belt is created with a concave shaped second side of the metal belt.

3. The method according to claim 1, wherein the metal belt is closed to form an endless belt before grinding the second side, by welding free ends of the endless belt or by a helical weld.

4. The method according to claim 3, wherein the endless belt is arranged to circulate between two rollers before grinding.

5. The method according to claim 4, wherein the endless belt is moved relative to a belt grinding device during grinding.

6. The method according to claim 3, wherein the metal belt is closed to an endless belt after straightening.

7. The method according to claim 1, characterized in that grinding introduces a residual compressive stress into the metal belt that corresponds to a residual compressive stress introduced into the metal belt by straightening.
